(19) United States
(12) Patent Application Publication
(10) Pub. No.: US 2026/0037655 A1
(43) Pub. Date: Feb. 5, 2026

(54) SELECTIVE ACCESS LEVELS OF PORTIONED FILES

(71) Applicant: Motorola Mobility LLC, Chicago, IL (US)

(72) Inventors: Amit Kumar Agrawal, Bangalore (IN); Krishnan Raghavan, Bangalore (IN)

(73) Assignee: Motorola Mobility LLC, Chicago, IL (US)

(21) Appl. No.: 18/791,030

(22) Filed: Jul. 31, 2024

(51) Int. Cl. G06F 21/62

(52) U.S. Cl. CPC G06F 21/6218

(57) ABSTRACT

In aspects of selective access levels of portioned files, a device includes a processor for receiving access instructions that indicate a first portion of a file is accessible by a first user account and a second portion of the file is accessible by a second user account. A portioned file can be generated by the device based at least in part on the access instructions such that a first level of access of the portioned file is granted to the first user account and a second level of access of the portioned file is granted to the second user account. The portioned file may be transmitted over a network to a second user account. In implementations, the access instructions are generated by an artificial intelligence algorithm based at least partially on a received agenda.

### BACKGROUND

Devices, such as smart devices, mobile devices (e.g., cellular phones, tablet devices, smartphones), consumer electronics, and the like, can be implemented for use in a wide range of environments and for a variety of different applications. For example, a device can implement a file sharing application that allows users linked with user accounts to store files, edit files, and share files with other users and/or user accounts. The file sharing application can allow multiple users and/or user accounts to collaborate on a shared file, such as a presentation file, a document file, and/or a spreadsheet file. Multiple users and/or user accounts can collaborate on the shared file by simultaneously editing, commenting, and/or viewing the shared file. Although file sharing and collaborative file editing can facilitate multiple users working together on a common goal from different physical locations, it is not without limitations. For example, users may accidentally make edits to the shared file that they were not supposed to causing confusion and additional work.

### BRIEF DESCRIPTION OF THE DRAWINGS

Implementations of the techniques for selective access levels of portioned files are described with reference to the following Figures. The same numbers may be used throughout to reference like features and components shown in the Figures.

FIGS. 1 and 2 illustrate example systems for selective access levels of portioned files in accordance with one or more implementations as described herein.

FIGS. 3 through 6 illustrate example graphical user interfaces (GUIs), which support selective access levels of portioned files in accordance with one or more implementations as described herein.

FIGS. 7 and 8 illustrate example methods for selective access levels of portioned files in accordance with one or more implementations of the techniques described herein.

FIG. 9 illustrates various components of an example device that can be used to implement the techniques for selective access levels of portioned files as described herein.

### DETAILED DESCRIPTION

Implementations of techniques for selective access levels of portioned files are described herein. In some examples, a user of a user account associated with a file sharing application may create a file to be shared with multiple users. A user account may be any type of account linking one or more devices to one or more users such that the one or more users may store, manipulate, process, edit, share, and/or otherwise provide access to data files associated with the user account. In implementations, a user account may be associated with different devices at different times and/or at the same time. For example, a user may log into a user account on different devices simultaneously or at different times. In implementations, a user of a first user account may create a file to collaborate on and share with a user of a second user account, such as a presentation file, a document file, and/or a spreadsheet file. This file may include multiple portions which may be discrete, identifiable segments of the file, such as slides of a presentation file, pages of a document file, and/or sheets of a spreadsheet file. For example, the generated file may have a first portion and a second portion. In examples, the users of the first user account and the second user account may agree that the first portion of the file is to be edited by the user of the first user account and the second portion of the file is to be edited by the user of the second user account. This may lead to issues in the file collaboration process, however. For example, the users of the first user account and the second user account may accidentally edit the wrong portion of the file causing unintended alterations and/or deletions and compromising the integrity of the file. Alternatively or in addition, the users of the first user account and the second user account may have to communicate extensively to coordinate edits which may slow down the collaboration process.

Thus, one solution to reduce or prevent accidental edits and extensive communication involves creating separate copies for the users collaborating on the file. For example, the user of the first account may get a first copy of the file, and the user of the second account may get a second copy of the file. When the users finish editing their copies, they may manually merge the two copies into the original file. However, this can cause more issues with the file collaboration process. For example, the manual merging process can be time-consuming and prone to errors. Additionally, this manual merging process may lead to confusion over which versions of the copies to include in the file leading to more errors. Users of the first account and the second account may also duplicate efforts when working on separate copies of the files leading to more time and effort when merging the copies. Maintaining multiple copies of the file and multiple versions of the copies of the file may also lead to storage and organization issues. Thus, selective access levels of portioned files would be beneficial to remedy the shortcomings of these solutions.

As described herein, a portioned file with one or more levels of access associated with one or more user accounts is generated and communicated with the one or more user accounts. In implementations, a first device associated with a first user account may receive a file, which may be any kind of data file that stores data and/or information, such as a presentation file, a document file, and/or a spreadsheet file. The file may include one or more portions which may be discrete, identifiable segments of the file, such as slides of a presentation file, pages of a document file, and/or sheets of a spreadsheet file. For example, the file may have a first portion and a second portion.

The first device associated with the first user account may also receive access instructions that instruct a file access manager implemented by the first device to generate the portioned file. The access instructions may include one or more levels of access associated with the one or more user accounts. For example, a first level of access may be designated for the first user account and a second level of access may be designated for the second user account. The one or more levels of access may selectively assign the one or more user accounts one or more types of access to the one or more portions of the file. The types of access may include one or more of a view access, a comment access, an edit access, and the like. For example, the first level of access may assign the first user account an edit access to the first portion of the file and a view access and/or a comment access to the second portion of the file. Alternatively or in addition, the second level of access may assign the second user account an edit access to the second portion of the file and a view access and/or a comment access to the first portion of the file. In this manner, the file access manager implements the access instructions to reduce accidental edits and excess communication. In implementations, the one or more levels of access may grant one or more types of access to the one or more portions of the file while restricting access to the remaining portions of the file. For example, the first level of access may grant the first user account view access, comment access, and/or edit access to the first portion of the file while hiding (e.g., not displaying) the second portion of the file. The second level of access may grant the second user account view access, comment access, and/or edit access to the second portion of the file, while hiding (e.g., not displaying) the first portion of the file.

In implementations, the file access manager may also automatically generate the access instructions and/or the file based on a received agenda. For example, the file access manager may implement an artificial intelligence module to receive an agenda included in an email communication and automatically generate the access instructions. The agenda may include one or more of a file template, file portions, file access level, and the like. The file template may specify one or more of a file type, a file theme, a file layout, a file font, and the like. The file portions may specify any number of portions to include in the file. The file access level(s) may include any number of levels of access as described above, such as the first level of access and the second level of access.

In implementations, the file access manager may generate the portioned file based on the file and the access instructions, such as by combining the file and the access instructions and communicating the portioned file to any number of user accounts and/or devices. For example, the file access manager may initiate a communication of the portioned file from the first device associated with the first user account to a second device associated with the second user account over one or more networks. One or more devices may implement one or more GUIs to display the portioned file and receive user input based in least in part on the access instructions and the one or more levels of access. For example, the second level of access may assign the second user account edit access to the second portion of the portioned file and comment and/or view access to the first portion of the portioned file. In this example, the second device can receive user input via the GUI to edit the second portion of the portioned file and to comment and/or view the first portion of the portioned file.

While features and concepts of the described techniques for selective access levels of portioned files can be implemented in any number of different devices, systems, environments, and/or configurations, implementations of the techniques for selective access levels of portioned files are described in the context of the following example systems, user interfaces, process flows, methods, and devices.

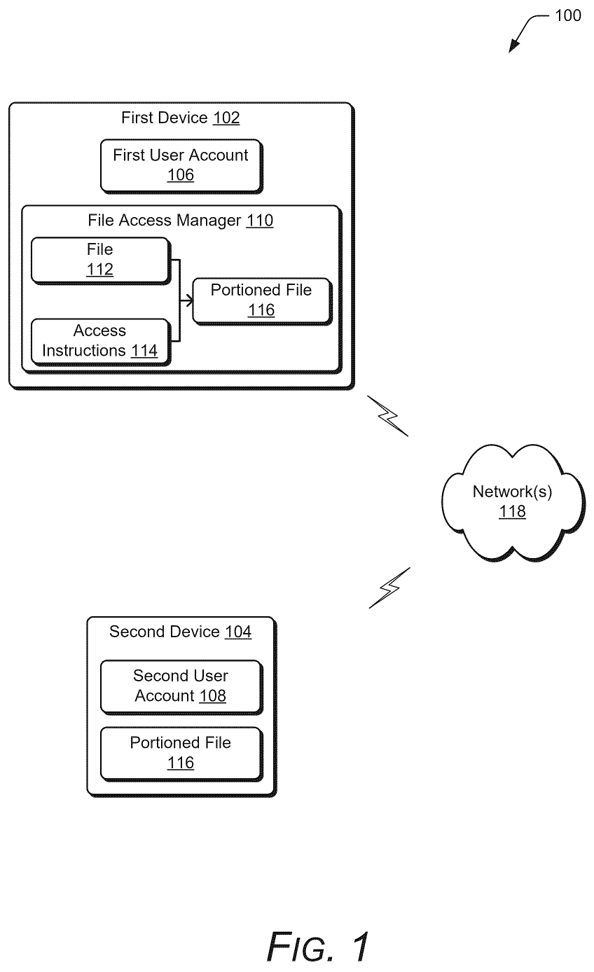

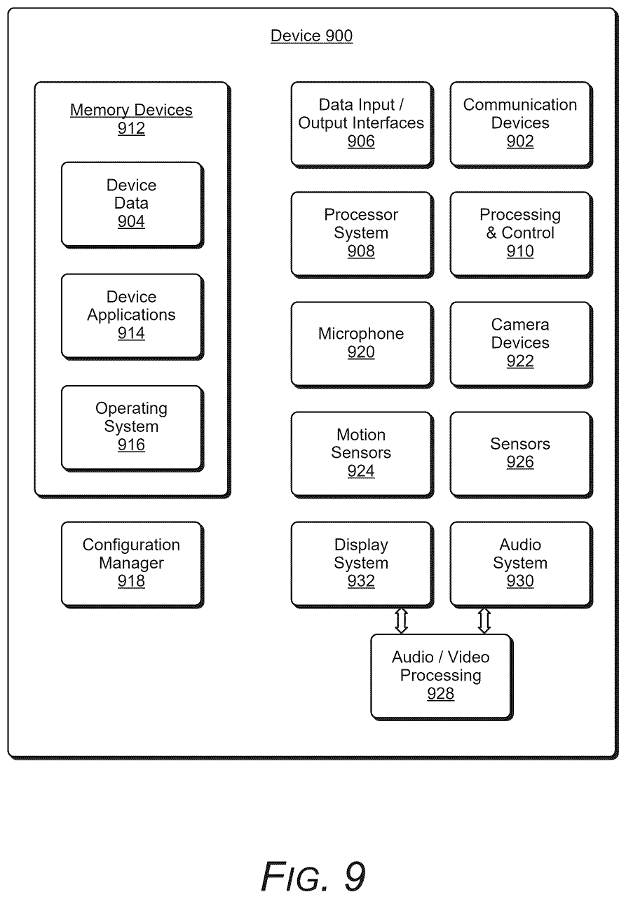

FIG. 1 illustrates an example system 100 in which aspects of selective access levels of portioned files can be implemented. The system 100 includes a first device 102 and a second device 104. The first device 102 and the second device 104 may represent any kind of electronic or computing devices that can access, display, edit, process, store, collect and/or manipulate data files. Examples of the first device 102 and the second device 104 can include any type of a wireless device, mobile device, mobile phone, flip phone, client device, companion device, tablet, computing device, laptop device, communication device, entertainment device, gaming device, media playback device, any other type of computing and/or electronic device, and/or any combination thereof. Alternatively or in addition, the first device 102 and/or the second device 104 may represent server devices, such as any type of server device, cloud storage, network system, and/or any other device that can collect, store, and communicate data. Generally, the first device 102 and the second device 104 can represent any type of an electronic and/or computing device implemented with various components, such as a processor system and memory, as well as any number and combination of different components as further described with reference to the example device 900 shown in FIG. 9. Although only two devices are illustrated in FIG. 1, it is to be appreciated that the techniques discussed herein operate analogously with any number of devices.

In implementations, the first device 102 and the second device 104 include various radios for wireless communication with other devices (e.g., via the one or more networks 118). For example, the first device 102 and the second device 104 may include a Bluetooth (BT) and/or Bluetooth Low Energy (BLE) transceiver and/or a near field communication (NFC) transceiver. The first device 102 and the second device 104 can also include a Wi-Fi radio, a global positioning system (GPS) radio, a radio for cellular communication (e.g., a third generation (3G) network, a fourth generation (4G) network, a fifth generation (5G) network), and/or any type of device communication interfaces.

In implementations of selective access levels of portioned files as described herein, the first device 102 may be associated with a first user account 106, and the second device may be associated with a second user account 108. The first user account 106 may be any type of account linked to a user associated with the first device 102, such that the user may store, manipulate, process, edit, and/or otherwise provide access to data files associated with the first user account. Similarly, the second user account 108 may be any type of account linked to a user associated with the second device 104, such that the user may store, manipulate, process, edit, and/or otherwise provide access to data files associated with the second user account. For example, the first user account 106 and the second user account 108 may be linked to a file sharing application. In implementations, a user account, such as the first user account 106 and/or the second user account 108, may be accessed by multiple devices, such as the first device 102 and/pr the second device 104 at different times and/or at the same time. For example, a user associated with the first user account 106 may access the first user account from the first device 102 and/or a third device simultaneously or at different times. Although only two user accounts are illustrated in FIG. 1, it is to be appreciated that the techniques discussed herein operate analogously with any number of user accounts.

In implementations, the first device 102 may implement a file access manager 110, which may be implemented as a module that includes independent processing, memory, and/or logic components functioning as a computing and/or electronic device integrated with the mobile device. Alternatively or in addition, the file access manager 110 can be implemented as a software application or software module, such as integrated with an operating system as computer-executable instructions that are executable with a processor of the first device 102. As a software application or module, the file access manager 110 may also be implemented as one or more artificial intelligence algorithms and/or machine learning algorithms. Alternatively or in addition, the file access manager 110 may be implemented in firmware and/or at least partially in computer hardware. For example, at least part of file access manager 110 may be executable by a computer processor, and/or at least part of the file access manager may be implemented in logic circuitry.

In implementations of selective access levels of portioned files as described herein, the first device 102 may implement the file access manager 110 to receive a file 112. The file 112 can be any kind of data file that stores data and/or information. For instance, the file 112 can be any kind of image file, document file, video file, presentation file, audio file, or any combination thereof. In implementations, the file 112 may be a shared file. For example, the file 112 may be shared, via a file sharing application, with multiple user accounts, such as the first user account 106 and the second user account 108. Alternatively or in addition, the file 112 may be generated in response to user input received. For example, the file access manager 110 may be generated in response to user input received, via a GUI of the first device 102, of a user associated with the first user account 106. In implementations, the file 112 may also include multiple portions. The portions of the file 112 may be discrete in that they are individually separate and distinct. For example, if the file 112 is a document file, the portions may be pages that are identifiable by page numbers. Alternatively or in addition, if the file 112 is a presentation file, the multiple portions may be slides that are identifiable by slide numbers. Alternatively or in addition, if the file 112 is a spreadsheet file, the portions may be sheets identifiable by sheet numbers. In implementations, the file 112 may be received by the file access manager 110, for example, through user input via a GUI to select a file type and/or a number of portions to include in the file. Alternatively or in addition, the file 112 may be received by the file access manager 110 from a separate user account, such as the second user account 108.

In implementations, the file access manager 110 may also receive access instructions 114. Generally, the access instructions 114 instruct the file access manager 110 to generate a portioned file 116 based at least in part on the file 112 and the access instructions 114. In implementations, the file access manager 110 generates the portioned file 116 by combining the file 112 and the access instructions 114. The access instructions 114 can include one or more levels of access that selectively allow one or more user accounts different levels of access to the portioned file 116. For example, the access instructions 114 may specify that the first user account 106 has a first access level to the portioned file 116, and the second user account 108 has a second access level to portioned file 116. In this example, the first access level may allow the first user account 106 to access the first portion of the portioned file 116 while restricting the first user account's access of the second portion of the portioned file. Alternatively or in addition, the second access level may allow the second user account 108 to access the second portion of the portioned file 116 while restricting the second user account's access of the first portion of the portioned file. The one or more levels of access of the access instructions 114 may further include one or more different types of access to multiple portions of the portioned file 116, such as view access, comment access, and/or edit access. For example, the first access level may grant the first user account 106 edit access of the first portion of the portioned file 116 while granting the first user account comment and/or view access of the second portion of the portioned file. Alternatively or in addition, the second access level may grant the second user account 108 edit access of the second portion of the portioned file 116 while granting the second user account comment and/or view access of the first portion of the portioned file. In implementations, the access instructions 114 may restrict access to one or more portions of the portioned file 116 such that the one or more portions of the portioned file are hidden from a user account. For example, the second level of access in the access instructions 114 may specify that the first portion of the portioned file 116 is hidden from the second user account 108.

In implementations of selective access levels of portioned files as described herein, the file access manager 110 may automatically generate the access instructions 114 and/or the file 112 based on a received agenda. The received agenda may be in the form of a message received on and/or sent by the first user account 106 and/or the first device 102, such as an email message. The received agenda may specify the access instructions 114, a type of the file 112, a template of the file, a number of portions, and or one or more file access levels to be included in the file. The file access manager 110 may implement any type of text recognition software, optical character recognition software, machine learning algorithm(s), and or artificial intelligence algorithm(s) that can recognize information from the received agenda, generate the access instructions 114, generate the file 112, and generate the portioned file 116. Alternatively or in addition, the access instructions 114 may be received via user input of a GUI implemented by a device. For example, a user associated with the first user account 106 may specify the access instructions 114 via user input of a GUI implemented by the first device 102.

In implementations, the file access manager 110 can initiate a communication of the portioned file 116 to the second user account 108 and/or the second device 104 over one or more networks 118 in response to generating the portioned file. The one or more networks 118, for example, can represent a combination of wired and wireless networks via which the first device 102 and the second device 104 can participate in various types of communication, such as wired, and/or wireless data communication.

The second device 104 can display the portioned file 116 via a user interface, such as a GUI, in response to receiving the portioned file. The second device 104 can receive user input, via the GUI, to access the portioned file 116 based at least in part on the access instructions 114 and/or the levels of access. For example, the second access level included in the access instructions 114 may grant the second user account 108 edit access of the second portion of the portioned file 116 while granting the second user account comment and/or view access of the first portion of the portioned file. In this example, the second device 104 can receive user input, via the GUI, which includes editing user input of the second portion of the portioned file 116 and comment and/or view user input of the first portion of the portioned file.

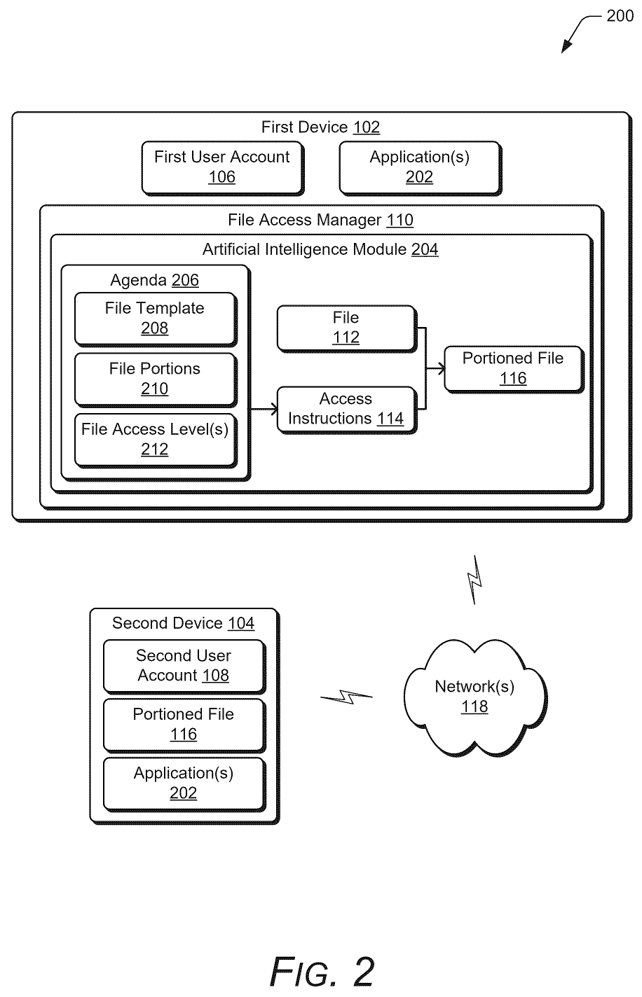

FIG. 2 illustrates an example system 200 for selective access levels of portioned files in accordance with one or more implementations as described herein. The example system 200 may implement aspects of the example system 100 described with reference to FIG. 1. For example, the system 200 may include the first device 102, the second device 104, and the one or more networks 118, which are examples of the corresponding features as described with reference to FIG. 1.

In implementations of selective access levels of portioned files as described herein, the first device 102 and the second device 104 are configured to run one or more applications 202. For example, the first device 102 and the second device 104 may have GUIs that display the one or more applications 202 to one or more users of the first device 102 and the second device 104. The one or more applications 202 may include an application to access a service linked to the user(s) through the first user account 106 and/or the second user account 108. This service may be any kind of service to store, manipulate, process, edit, and/or otherwise provide access to data files associated with user accounts (e.g., the first user account 106 and/or the second user account 108), such as a file sharing application. Alternatively or in addition, the service may be an online service that provides users associated with user accounts (e.g., the first user account 106 and/or the second user account 108) with storing, manipulating, processing, editing, and/or accessing capabilities of data files that may be stored in a database. The database may be an example of a remote database (e.g., cloud or network-based database), a physical database, or the like. For example, a user of the first device 102 may be able to utilize the one or more applications 202 to select files (e.g., the file 112) associated with the first user account 106 for editing, manipulating, processing, sharing, and/or accessing via a GUI of the first device. In implementations, the one or more applications 202 may also be a service to allow for sharing files between user accounts (e.g., the first user account 106 and/or the second user account 108) such that files are simultaneously accessible by multiple user accounts associated with the service. For example, the one or more applications 202 may allow a user associated with the first user account 106 to share the file 112 with the second user account 108.

In this example system 200, the first device 102 implements the file access manager 110 that utilizes an artificial intelligence module 204. The artificial intelligence module 204 implements artificial intelligence or machine learning, which refers to machine-implemented intelligence for performing various tasks on data, such as data analysis, data classification, data modification, data generation, and so forth. The artificial intelligence module 204 may be implemented as a module that includes independent processing, memory, and/or logic components functioning as a computing and/or electronic device integrated with the mobile device. Alternatively or in addition, the artificial intelligence module 204 can be implemented as a software application or software module, such as integrated with an operating system as computer-executable instructions that are executable with a processor of the first device 102. As a software application or module, the artificial intelligence module 204 may also be implemented as one or more artificial intelligence algorithms, machine learning algorithms, text recognition algorithms, and/or optical character recognition algorithms. Alternatively or in addition, the artificial intelligence module 204 may be implemented in firmware and/or at least partially in computer hardware. For example, at least part of artificial intelligence module 204 may be executable by a computer processor, and/or at least part of the artificial intelligence module may be implemented in logic circuitry.

In implementations, the first device 102 receives an agenda 206 and communicates the agenda to the artificial intelligence module 204 implemented by the file access manager 110. The agenda 206 may be any sort of communication, message, and/or data file received on the first device 102 and/or the first user account 106 that informs the artificial intelligence module 204 to generate the access instructions 114. Alternatively or in addition, the agenda 206 may be any sort of communication, message, and/or data file received on the first device 102 that may inform the artificial intelligence module 204 to generate the file 112. For example, the agenda 206 may be an email communication received on the first device 102 that includes the agenda with information available to the artificial intelligence module 204 to automatically generate the access instructions 114 and/or the file 112 in response to receiving the email communication. Alternatively or in addition, the agenda 206 may be received via user input of a GUI implemented on the first device 102.

In implementations, the agenda 206 may include a file template 208, file portions 210, and/or file access level(s) 212. The artificial intelligence module 204 may receive the agenda 206 and extract and/or generate the file template 208, the file portions 210, and/or the file access level(s) 212. The file template 208 may include any instructions and/or data that describe the file 112 and/or the portioned file 116, such as a file type, a file theme, a file layout, a file font, and the like. The file portions 210 may specify any number of portions to include in the file 112 and/or the portioned file 116, such as a number of slides in a presentation file, a number of pages in a document file, and/or a number of sheets in a spreadsheet file. The file access level(s) 212 may specify any number of user accounts (e.g., the first user account 106 and the second user account 108) that may access the portioned file 116, which specified user account(s) may access the portioned file, level(s) of access the user account(s) are granted, type(s) of access, and/or the portions of the portioned file to which the user accounts are granted access. The type(s) of access included in the file access level(s) 212 may include instructions to grant view access, to grant comment access, to grant edit access, and/or to hide portions of the portioned file 116 from user accounts (e.g., the first user account 106 and/or the second user account 108). For example, the file template 208 may specify that the file 112 is a presentation file, the file portions 210 may specify the file 112 has a first portion and a second portion (i.e., a first slide and a second slide), and the file access level(s) 212 may specify that the first user account 106 has a first level of access (e.g., edit access of the first portion and view access of the second portion) and the second user account 108 has a second level of access (e.g., edit access of the second portion and view access of the first portion).

The artificial intelligence module 204 implemented by the file access manager 110 on the first device 102 can generate the portioned file 116 based at least in part on the file 112 and/or the access instructions 114. For example, the artificial intelligence module 204 may automatically generate the portioned file 116 by combining the access instructions 114 with the file 112 in response to generating the access instructions and/or the file. The portioned file 116 may be generated to include the file template 208, the file portions 210, and/or the file access level(s) 212 of the access instructions 114. For example, the portioned file 116 may be a presentation file according to the file template 208, include a first portion and a second portion according to the file portions 210, and include a first level of access and a second level of access according to the file access level(s) 212. The first level of access may allow the first user account 106 to access the first portion of the portioned file 116 while restricting the first user account's access of the second portion of the portioned file. Alternatively or in addition, the second access level may allow the second user account 108 to access the second portion of the portioned file 116 while restricting the second user account's access of the first portion of the portioned file. The first level of access and the second level of access may include one or more different types of access to the first portion and the second portion of the portioned file 116, such as view access, comment access, and/or edit access. For example, the first access level may grant the first user account 106 edit access of the first portion of the portioned file 116 while granting the first user account comment and/or view access of the second portion of the portioned file. Alternatively or in addition, the second access level may grant the second user account 108 edit access of the second portion of the portioned file 116 while granting the second user account comment and/or view access of the first portion of the portioned file. In implementations, the access instructions 114 may restrict access to one or more portions of the portioned file 116 such that the one or more portions of the portioned file are hidden from (not displayed for) a user account. For example, the access instructions 114 may specify that the first portion of the portioned file 116 is hidden from (not displayed for) the second user account 108.

In implementations, the file access manager 110 and/or the artificial intelligence module 204 can initiate a communication of the portioned file 116 to any number or devices or user accounts over the one or more networks 118. For example, the file access manager 110 and/or the artificial intelligence module 204 can initiate a communication of the portioned file 116 to the second user account 108 and/or the second device 104 over the one or more networks 118 in response to generating the portioned file. In implementations, the portioned file 116 may be communicated to the second user account 108 and/or the second device 104 in response to generating the portioned file 116 with access instructions 114 specifying the portioned file is to be a shared file shared with the second user account. The second device 104 can display the portioned file 116 via a user interface, such as a GUI, in response to receiving the portioned file. The second device 104 can receive user input, via the GUI, to access the portioned file 116 based at least in part on the access instructions 114 and/or the file access level(s) 212. For example, the access level(s) 212 may specify that the second user account 108 is granted edit access of a second portion of the portioned file 116 while granting the second user account comment and/or view access of a first portion of the portioned file. In this example, the second device 104 can receive user input, via the GUI, which includes editing user input of the second portion of the portioned file 116 and comment and/or view user input of the first portion of the portioned file.

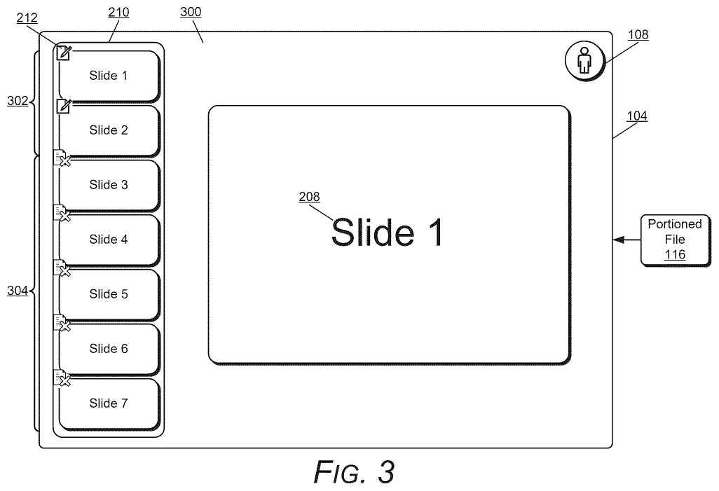

FIG. 3 illustrates an example GUI 300, which supports selective access levels of portioned files in accordance with one or more implementations as described herein. The example GUI 300 may implement aspects of the example system 100, as well as the example system 200 as shown and described with reference to FIGS. 1 and 2. For example, the GUI 300 may illustrate an example of the portioned file 116 displayed at the second device 104 and/or the first device 102 as described with reference to FIGS. 1 and 2.

In the example GUI 300, the second device 104 displays the portioned file 116 for a user associated with the second user account 108, for example, in response to receiving the portioned file from the first device 102. In alternative implementations, the first device 102 may implement the GUI 300 to display the portioned file 116 for a user associated with the first user account 106 in response to communicating the portioned file to the second device 104.

The GUI 300 can display the portioned file 116 to include the file template 208 which may specify a file type, a file theme, a file layout, a file font, and the like. In this example GUI 300, the file template 208 specifies the portioned file 116 is a presentation file. The GUI 300 may also display the portioned file 116 to include the file portions 210 which may specify any number of portions to include in the portioned file. In this example GUI 300, the file portions 210 specify a first portion 302 to include slide one and slide two, and a second portion 304 to include slides three through seven. The GUI 300 may also display the portioned file 116 to include the file access level(s) 212 which can specify any number of user accounts may access the portioned file, which specified user account(s) may access the portioned file, level(s) of access the user account(s) are granted, type(s) of access, and/or the portions of the portioned file to which the user accounts are granted. In this example GUI 300, the file access level(s) 212 specify that the second user account 108 is granted edit access to the first portion 302 and a restricted access to the second portion 304, such as view access and/or comment access.

The GUI 300 may also receive user input to access the portioned file 116 based at least in part on the file access level(s) 212. For example, the GUI 300 may receive user input to edit the first portion 302 of the portioned file 116 in response to the file access level(s) 212 specifying the second user account 108 has edit access of the first portion 302. Alternatively or in addition, the GUI 300 may receive user input to comment on and/or view the second portion 304 of the portioned file 116 in response to the file access level(s) 212 specifying the second user account 108 has comment access and/or view access of the second portion. Alternatively, the GUI 300 may hide the second portion 304 of the portioned file 116 in response to the file access level(s) 212 specifying the second user account 108 is granted restricted access to the second portion.

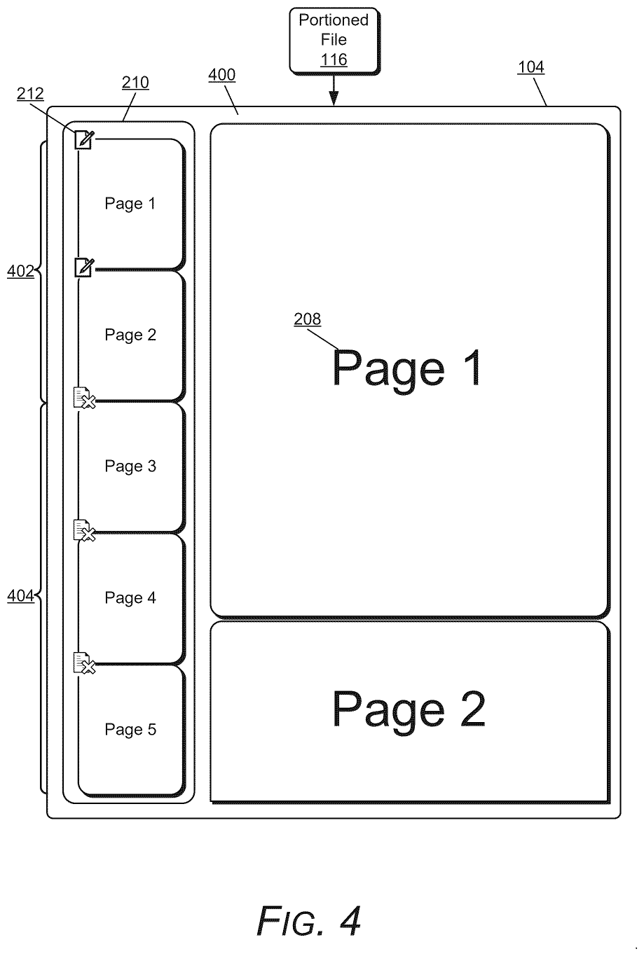

FIG. 4 illustrates an example GUI 400, which supports selective access levels of portioned files in accordance with one or more implementations as described herein. The example GUI 400 may implement aspects of the example system 100, as well as the example system 200 as shown and described with reference to FIGS. 1 and 2. For example, the GUI 400 may illustrate an example of the portioned file 116 displayed at the second device 104 and/or the first device 102 as described with reference to FIGS. 1 and 2.

In the example GUI 400, the second device 104 displays the portioned file 116 for a user associated with the second user account 108, for example, in response to receiving the portioned file from the first device 102. In alternative implementations, the first device 102 may implement the GUI 400 to display the portioned file 116 for a user associated with the first user account 106 in response to communicating the portioned file to the second device 104.

The GUI 400 can display the portioned file 116 to include the file template 208 which may specify a file type, file theme, a file layout, a file font, and the like. In this example GUI 400, the file template 208 specifies the portioned file 116 is a document file. The GUI 400 may also display the portioned file 116 to include the file portions 210 which may specify any number of portions to include in the portioned file. In this example GUI 400, the file portions 210 specify a first portion 402 to include page one and page two, and a second portion 404 to include pages three through five. The GUI 400 may also display the portioned file 116 to include the file access level(s) 212 which can specify any number of user accounts may access the portioned file, which specified user account(s) may access the portioned file, level(s) of access the user account(s) are granted, type(s) of access, and/or the portions of the portioned file to which the user accounts are granted. In this example GUI 400, the file access level(s) 212 specify that the second user account 108 is granted edit access to the first portion 402 and a restricted access to the second portion 404, such as view access and/or comment access.

The GUI 400 may also receive user input to access the portioned file 116 based at least in part on the file access level(s) 212. For example, the GUI 400 may receive user input to edit the first portion 402 of the portioned file 116 in response to the file access level(s) 212 specifying the second user account 108 has edit access of the first portion 402. Alternatively or in addition, the GUI 400 may receive user input to comment on and/or view the second portion 404 of the portioned file 116 in response to the file access level(s) 212 specifying the second user account 108 has comment access and/or view access of the second portion. Alternatively, the GUI 400 may hide the second portion 404 of the portioned file 116 in response to the file access level(s) 212 specifying the second user account 108 is granted restricted access to the second portion.

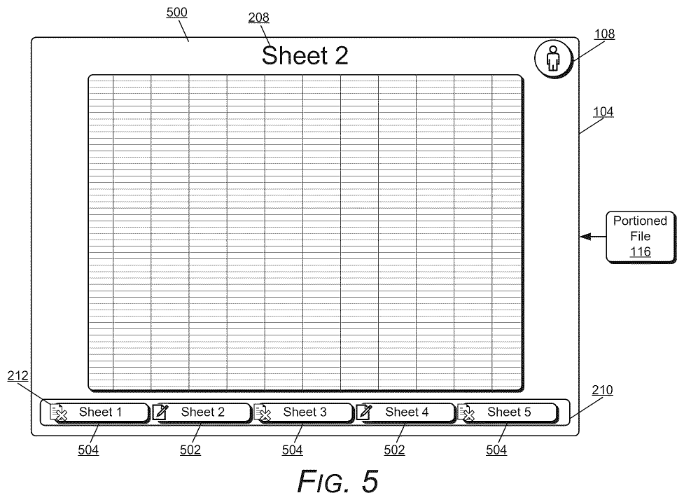

FIG. 5 illustrates an example GUI 500, which supports selective access levels of portioned files in accordance with one or more implementations as described herein. The example GUI 500 may implement aspects of the example system 100, as well as the example system 200 as shown and described with reference to FIGS. 1 and 2. For example, the GUI 500 may illustrate an example of the portioned file 116 displayed at the second device 104 and/or the first device 102 as described with reference to FIGS. 1 and 2.

In the example GUI 500, the second device 104 displays the portioned file 116 for a user associated with the second user account 108, for example, in response to receiving the portioned file from the first device 102. In alternative implementations, the first device 102 may implement the GUI 500 to display the portioned file 116 for a user associated with the first user account 106 in response to communicating the portioned file to the second device 104.

The GUI 500 can display the portioned file 116 to include the file template 208 which may specify a file type, file theme, a file layout, a file font, and the like. In this example GUI 500, the file template 208 specifies the portioned file 116 is a spreadsheet file. The GUI 500 may also display the portioned file 116 to include the file portions 210 which may specify any number of portions to include in the portioned file. In this example GUI 500, the file portions 210 specify a first portion 502 to include sheet two and sheet four, and a second portion 504 to include sheet one, sheet three, and sheet five. The GUI 500 may also display the portioned file 116 to include the file access level(s) 212 which can specify any number of user accounts may access the portioned file, which specified user account(s) may access the portioned file, level(s) of access the user account(s) are granted, type(s) of access, and/or the portions of the portioned file to which the user accounts are granted. In this example GUI 500, the file access level(s) 212 specify that the second user account 108 is granted edit access to the first portion 502 and a restricted access to the second portion 504, such as view access and/or comment access.

The GUI 500 may also receive user input to access the portioned file 116 based at least in part on the file access level(s) 212. For example, the GUI 500 may receive user input to edit the first portion 502 of the portioned file 116 in response to the file access level(s) 212 specifying the second user account 108 has edit access of the first portion 502. Alternatively or in addition, the GUI 500 may receive user input to comment on and/or view the second portion 504 of the portioned file 116 in response to the file access level(s) 212 specifying the second user account 108 has comment access and/or view access of the second portion. Alternatively, the GUI 500 may hide the second portion 504 of the portioned file 116 in response to the file access level(s) 212 specifying the second user account 108 is granted restricted access to the second portion.

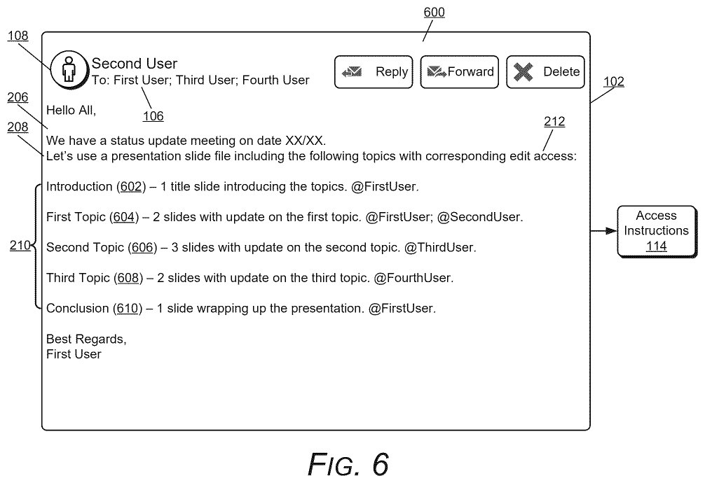

FIG. 6 illustrates an example GUI 600, which supports selective access levels of portioned files in accordance with one or more implementations as described herein. The example GUI 600 may implement aspects of the example system 100, as well as the example system 200 as shown and described with reference to FIGS. 1 and 2. For example, the GUI 600 may illustrate an example of the agenda 206 displayed at the first device 102 and/or the second device 104 as described with reference to FIGS. 1 and 2.

In the example GUI 600, the first device 102 displays the agenda 206 for a user associated with the first user account 106. The agenda 206 may be any sort of communication, message, and/or data file received on the first device 102 and/or the first user account 106 that informs the artificial intelligence module 204 implemented by the first device to generate the access instructions 114 and/or the file 112 as described with reference to FIG. 2. For example, the artificial intelligence module 204 implemented by the first device 102 may automatically initiate a generation of the access instructions 114 and/or the file 112 in response to receiving the agenda 206. Alternatively or in addition, the artificial intelligence module 204 implemented by the first device 102 may automatically initiate a generation of the access instructions 114 and/or the file 112 in response to communicating the agenda 206 to one or more user accounts. In this example GUI 600, the agenda 206 is received as an email communication initiated by the second user account 108. Alternatively or in addition, the agenda 206 may be a communication, such as an email communication, initiated by a user associated with the first user account 106 and/or the first device 102. Alternatively or in addition, the agenda 206 may be received via user input of the GUI 600 implemented by the first device 102.

The agenda 206 may include the file template 208, the file portions 210, and/or the file access level(s) 212. The artificial intelligence module 204 implemented by the first device 102 may receive the agenda 206 and extract and/or generate the file template 208, the file portions 210, and/or the file access level(s) 212 to generate the access instructions 114. Alternatively, or in addition, the artificial intelligence module 204 implemented by the first device may extract and/or generate the file template 208, the file portions 210, and/or the file access level(s) 212 in response to communicating the agenda 206 to one or more user accounts. The file template 208 may include any instructions and/or data that describe the file 112 and/or the portioned file 116, such as a file type, a file theme, a file layout, a file font, and the like. In this example GUI 600, the file template 208 includes information indicating the file type to be a presentation slide file. The file portions 210 may specify any number of portions to include in the file 112 and/or the portioned file 116, such as a number of slides in a presentation file, a number of pages in a document file, and/or a number of sheets in a spreadsheet file. In this example GUI 600, the file portions 210 include a first portion 602 including one slide, a second portion 604 including two slides, a third portion 606 including three slides, a fourth portion 608 including two slides, and a fifth portion 610 including one slide. The file access level(s) 212 may specify any number of user accounts (e.g., the first user account 106 and the second user account 108) that may access the portioned file 116, which specified user account(s) may access the portioned file, level(s) of access the user account(s) are granted, type(s) of access, and/or the portions of the portioned file to which the user accounts are granted access. The type(s) of access included in the file access level(s) 212 may include instructions to grant view access, to grant comment access, to grant edit access, and/or to hide portions of the portioned file 116 from user accounts (e.g., the first user account 106 and/or the second user account 108). In this example GUI 600, the file access level(s) 212 grant edit access of the first portion 602 to a first user (e.g., a user associated with the first user account 106), edit access of the second portion 604 to a first user and a second user (e.g., the user(s) associated with the first user account 106 and the second user account 108), edit access of the third portion 606 to a third user, edit access of the fourth portion 608 to a fourth user, and edit access of the fifth portion 610 to the first user.

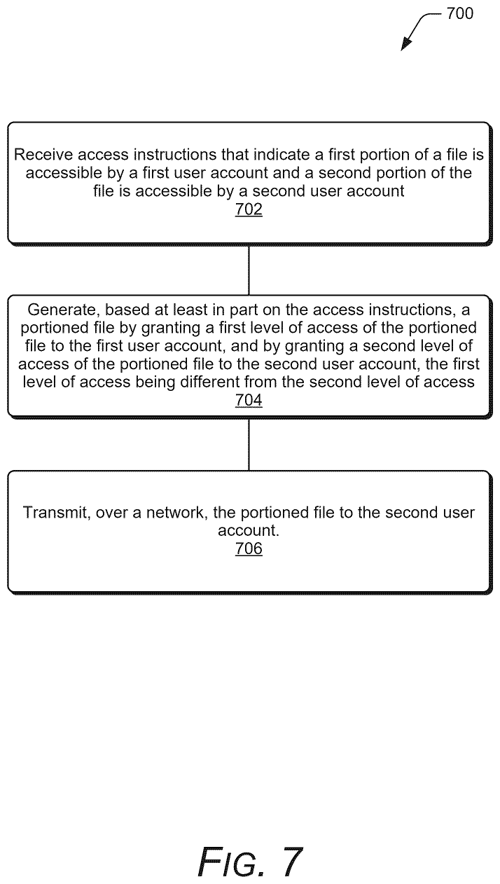

FIG. 7 illustrates one or more example methods 700 for selective access levels of portioned files. The order in which the method is described is not intended to be construed as a limitation, and any number or combination of the described method operations can be performed in any order to perform a method, or an alternate method.

At 702, access instructions are received that indicate a first portion of a file is accessible by a first user account and a second portion of the file is accessible by a second user account. For instance, the access instructions 114 can be received by the file access manager 110 implemented by the first device 102. The access instructions 114 can indicate that a first portion of the file 112 is accessible by the first user account 106 and a second portion of the file 112 is accessible by the second user account 108. In implementations, the access instructions are generated by an artificial intelligence algorithm based at least partially on a received agenda. For instance, the access instructions 114 can be generated by the artificial intelligence module 204 based at least partially on the agenda 206. In implementations, the received agenda is an email received by the first user account. For instance, the first user account 106 associated with the first device 102 may receive the agenda 206 as an email communication. In implementations, the received agenda specifies the first level of access and the second level of access. For instance, the agenda 206 can include the file access level(s) 212 which may include the first level of access and the second level of access. In implementations, the received agenda includes a template of the file specifying a type of the file. For instance, the agenda 206 may include the file template 208 specifying a type of the file 112. In implementations, the received agenda specifies a number of portions to be included in the portioned file. For instance, the agenda 206 may include the file portions 210 that specify a number of portions to be included in the portioned file 116.

At 704, a portioned file is generated based at least in part on the access instructions by granting a first level of access of the portioned file to the first user account, and by granting a second level of access of the portioned file to the second user account, the first level of access being different from the second level of access. For instance, the portioned file 116 can be generated based on the access instructions 114 which may include granting a first level of access of the portioned file to the first user account 106, and by granting a second level of access of the portioned file to the second user account 108. In implementations, the first level of access includes access to the first portion of the file and restricts access to the second portion of the file, while the second level of access includes access to the second portion of the file and restricts access to the first portion of the file. For instance, the first level of access can include granting the first user account 106 access to the first portion of the file 112 while restricting access of the first user account to the second portion of the file. The second level of access can include granting the second user account 108 access to the second portion of the file 112 while restricting access of the second user account to the first portion of the file. In implementations, the first level of access includes one or more of a view access, a comment access, and an edit access to the first portion and one or more of the view access, the comment access, and the edit access to the second portion, and the second level of access includes one or more of the view access, the comment access, and the edit access to the first portion and one or more of the view access, the comment access, and the edit access to the second portion. For instance, the first level of access of the file access level(s) 212 can include at least one of view access, comment access, and/or edit access of the first portion and/or the second portion of the file 112. The second level of access of the file access level(s) 212 can include at least one view access comment access, and/or edit access of the first portion and/or the second portion of the file 112.

At 706, the portioned file is transmitted to the second user account over a network. For instance, the file access manager 110 may initiate a communication of the portioned file 116 from the first device 102 to the second device 104 and/or the second user account 108 over the one or more networks 118.

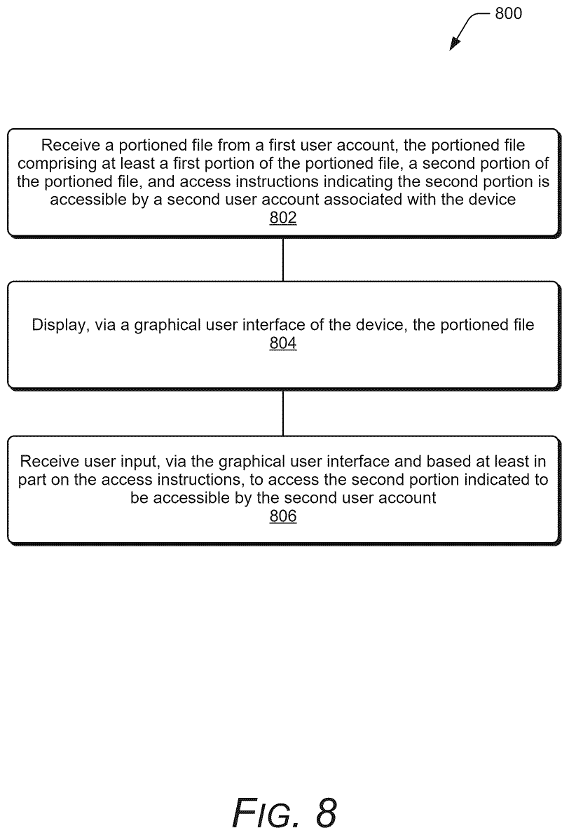

FIG. 8 illustrates one or more example methods 800 for selective access levels of portioned files. The order in which the method is described is not intended to be construed as a limitation, and any number or combination of the described method operations can be performed in any order to perform a method, or an alternate method.

At 802, a portioned file is received from a first user account where the first portioned includes at least a first portion of the portioned file, a second portion of the portioned file, and access instructions indicating the second portion is accessible by a second user account associated with a device. For instance, the second device 104 can receive the portioned file 116 from the first device 102. The portioned file 116 may include a first portion, a second portion, and the access instructions 114 indicating the second portion is accessible by the second user account 108 associated with the second device 104. In implementations, the access instructions are generated by an artificial intelligence algorithm based at least partially on an agenda. For instance, the access instructions 114 may be generated by the artificial intelligence module 204 based at least partially on the agenda 206. In implementations, the agenda is an email received on a device associated with the first user account. For instance, the agenda 206 may be included in an email communication received on the first device 102 associated with the first user account 106. In implementations, the agenda grants a level of access of the second portion to the second user account. For instance, the agenda 206 may include the file access level(s) 212 that grant the second user account 108 a level of access to the second portion. In implementations, the level of access includes access to the second portion of the portioned file and restricts access to the first portion of the portioned file. For instance, the file access level(s) 212 may include the level of access that grants the second user account 108 access to the second portion of the portioned file 116 and restricts access of the second user account to the first portion of the portioned file. In implementations, to access the second portion includes at least one of view access, comment access, and edit access to the second portion. For instance, the file access level(s) 212 may include an access type, such as view access, comment access, and/or edit access.

At 804, the portioned file is displayed via a graphical user interface of the device. For instance, the portioned file 116 may be displayed via a GUI of the second device 104 in response to receiving the portioned file.

At 806, user input is received, via the graphical user interface and based at least in part on the access instructions, to access the second portion indicated to be accessible by the second user account. For instance, the GUI of the second device 104 may receive user input to access the second portion of the portioned file 116 that is indicated to be accessible by the second user account 108.

The example methods 700 and 800 are described with reference to respective FIGS. 7 and 8 in accordance with one or more implementations of selective access levels of portioned files, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 9 illustrates various components of an example device 900, which can implement aspects of the techniques and features for selective access levels of portioned file, as described herein. The example device 900 can be implemented as any of the devices described with reference to the previous FIGS. 1 through 8, such as any type of a wireless device, mobile device, mobile phone, flip phone, client device, companion device, paired device, display device, tablet, computing, communication, entertainment, gaming, media playback, and/or any other type of computing, consumer, and/or electronic device. For example, the first device 102 and the second device 104 described with reference to FIGS. 1 through 8 may be implemented as the example device 900.

The example device 900 can include various, different communication devices 902 that enable wired and/or wireless communication of device data 904 with other devices. The device data 904 can include any of the various device's data and content that is generated, processed, determined, received, stored, and/or communicated from one computing device to another. Generally, the device data 904 can include any form of audio, video, image, graphics, and/or electronic data that is generated by applications executing on a device. The communication devices 902 can also include transceivers for cellular phone communication and/or for any type of network data communication.

The example device 900 can also include various, different types of data input/output (I/O) interfaces 906, such as data network interfaces that provide connection and/or communication links between the devices, data networks, and other devices. The I/O interfaces 906 can be used to couple the device to any type of components, peripherals, and/or accessory devices, such as a computer input device that may be integrated with the example device 900. The I/O interfaces 906 may also include data input ports via which any type of data, information, media content, communications, messages, and/or inputs can be received, such as user inputs to the device, as well as any type of audio, video, image, graphics, and/or electronic data received from any content and/or data source.

The example device 900 includes a processor system 908 of one or more processors (e.g., any of microprocessors, controllers, and the like) and/or a processor and memory system implemented as a system-on-chip (SoC) that processes computer-executable instructions. The processor system 908 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified at 910. The example device 900 may also include any type of a system bus or other data and command transfer system that couples the various components within the device. A system bus can include any one or combination of different bus structures and architectures, as well as control and data lines.

The example device 900 also includes memory and/or memory devices 912 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 912 include volatile memory and non-volatile memory, fixed and removable media devices, and any suitable memory device or electronic data storage that maintains data for computing device access. The memory devices 912 can include various implementations of random-access memory (RAM), read-only memory (ROM), flash memory, and other types of storage media in various memory device configurations. The example device 900 may also include a mass storage media device.

The memory devices 912 (e.g., as computer-readable storage memory) provide data storage mechanisms, such as to store the device data 904, other types of information and/or electronic data, and various device applications 914 (e.g., software applications and/or modules). For example, an operating system 916 can be maintained as software instructions with a memory device 912 and executed by the processor system 908 as a software application. The device applications 914 may also include a device manager, such as any form of a control application, software application, signal processing and control module, code that is specific to a particular device, a hardware abstraction layer for a particular device, and so on.

In this example, the device 900 includes a configuration manager 918 that implements various aspects of the described features and techniques described herein. The configuration manager 918 can be implemented with hardware components and/or in software as one of the device applications 914, such as when the example device 900 is implemented as the first device 102 and/or the second device 104 described with reference to FIGS. 1 through 8. An example of the configuration manager 918 is the file access manager 110 and/or the artificial intelligence module 204 implemented in the first device 102, and/or the second device 104, such as a software application and/or as hardware components in the wireless device. In implementations, the configuration manager 918 may include independent processing, memory, and logic components as a computing and/or electronic device integrated with the example device 900.

The example device 900 can also include a microphone 920 and/or camera devices 922, as well as proximity and/or motion sensors 924, such as may be implemented as components of an inertial measurement unit (IMU). The proximity and/or motion sensors 924 can be implemented with various sensors, such as a gyroscope, an accelerometer, and/or other types of motion sensors to sense motion of the device. The motion sensors 924 can generate sensor data vectors having three-dimensional parameters (e.g., rotational vectors in x, y, and z-axis coordinates) indicating location, position, acceleration, rotational speed, and/or orientation of the device. The example device 900 can also include one or more power sources 926, such as when the device is implemented as a wireless device, the first device 102, and/or the second device 104. The power sources may include a charging and/or power system, and can be implemented as a flexible strip battery, a rechargeable battery, a charged super-capacitor, and/or any other type of active or passive power source.

The example device 900 can also include an audio and/or video processing system 928 that generates audio data for an audio system 930 and/or generates display data for a display system 932. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 900. Alternatively, the audio system and/or the display system are external, peripheral components to the example device.

Although implementations of selective access levels of portioned files have been described in language specific to features and/or methods, the appended claims are not necessarily limited to the specific features or methods described. Rather, the specific features and methods are disclosed as example implementations of selective access levels of portioned files, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In some aspects, the techniques described herein relate to a device, including: a memory; and at least one processor coupled with the memory and configured to cause the device to: receive access instructions that indicate a first portion of a file is accessible by a first user account and a second portion of the file is accessible by a second user account; generate, based at least in part on the access instructions, a portioned file by granting a first level of access of the portioned file to the first user account, and by granting a second level of access of the portioned file to the second user account, the first level of access being different from the second level of access; and transmit, over a network, the portioned file to the second user account.

In some aspects, the techniques herein relate to a device, wherein the access instructions are generated by an artificial intelligence algorithm based at least partially on a received agenda.

In some aspects, the techniques herein relate to a device, wherein the received agenda is an email received by the first user account.

In some aspects, the techniques herein relate to a device, wherein the received agenda specifies the first level of access and the second level of access.

In some aspects, the techniques herein relate to a device, wherein the received agenda includes a template of the file specifying a type of the file.

In some aspects, the techniques herein relate to a device, wherein the received agenda specifies a number of portions to be included in the portioned file.

In some aspects, the techniques herein relate to a device, wherein the first level of access includes access to the first portion of the file and restricts access to the second portion of the file, while the second level of access includes access to the second portion of the file and restricts access to the first portion of the file.

In some aspects, the techniques herein relate to a device, wherein the first level of access includes one or more of a view access, a comment access, and an edit access to the first portion and one or more of the view access, the comment access, and the edit access to the second portion, and the second level of access includes one or more of the view access, the comment access, and the edit access to the first portion and one or more of the view access, the comment access, and the edit access to the second portion.

In some aspects, the techniques herein relate to a device, including: a memory; and at least one processor coupled with the memory and configured to cause the device to: receive a portioned file from a first user account, the portioned file comprising at least a first portion of the portioned file, a second portion of the portioned file, and access instructions indicating the second portion is accessible by a second user account associated with the device; display, via a graphical user interface of the device, the portioned file; and receive user input, via the graphical user interface and based at least in part on the access instructions, to access the second portion indicated to be accessible by the second user account.

In some aspects, the techniques herein relate to a device, wherein the access instructions are generated by an artificial intelligence algorithm based at least partially on an agenda.

In some aspects, the techniques herein relate to a device, wherein the agenda is an email received on a device associated with the first user account.

In some aspects, the techniques herein relate to a device, wherein the agenda grants a level of access of the second portion to the second user account.

In some aspects, the techniques herein relate to a device, wherein the level of access includes access to the second portion of the portioned file and restricts access to the first portion of the portioned file.

In some aspects, the techniques herein relate to a device, wherein to access the second portion includes at least one of view access, comment access, and edit access to the second portion.

In some aspects, the techniques herein relate to a method, including: receiving access instructions that indicate a first portion of a file is accessible by a first user account and a second portion of the file is accessible by a second user account; generating, based at least in part on the access instructions, a portioned file by granting a first level of access of the portioned file to the first user account, and by granting a second level of access editing access of the portioned file to the second user account, the first level of access being different from the second level of access; and transmitting, over a network, the portioned file from the first user account to the second user account.

In some aspects, the techniques herein relate to a method, wherein the access instructions are generated by an artificial intelligence algorithm based at least partially on a received agenda.

In some aspects, the techniques herein relate to a method, wherein the received agenda is an email received by the first user account.

In some aspects, the techniques herein relate to a method, wherein the received agenda specifies the first level of access and the second level of access.

In some aspects, the techniques herein relate to a method, wherein the first level of access includes access to the first portion of the file and restricts access to the second portion of the file, while the second level of access includes access to the second portion of the file and restricts access to the first portion of the file.

In some aspects, the techniques herein relate to a method, wherein the first level of access includes one or more of a view access, a comment access, and an edit access to the first portion and one or more of the view access, the comment access, and the edit access to the second portion, and the second level of access includes one or more of the view access, the comment access, and the edit access to the first portion and one or more of the view access, the comment access, and the edit access to the second portion.

1. A device, comprising:
a memory; and
at least one processor coupled with the memory and configured to cause the device to:
receive access instructions that indicate a first portion of a file is accessible by a first user account and a second portion of the file is accessible by a second user account;
generate, based at least in part on the access instructions, a portioned file by granting a first level of access of the portioned file to the first user account, and by granting a second level of access of the portioned file to the second user account, the first level of access being different from the second level of access; and
transmit, over a network, the portioned file to the second user account.

2. The device of claim 1, wherein the access instructions are generated by an artificial intelligence algorithm based at least partially on a received agenda.

3. The device of claim 2, wherein the received agenda is an email received by the first user account.

4. The device of claim 2, wherein the received agenda specifies the first level of access and the second level of access.

5. The device of claim 2, wherein the received agenda includes a template of the file specifying a type of the file.

6. The device of claim 2, wherein the received agenda specifies a number of portions to be included in the portioned file.

7. The device of claim 1, wherein the first level of access includes access to the first portion of the file and restricts access to the second portion of the file, while the second level of access includes access to the second portion of the file and restricts access to the first portion of the file.

8. The device of claim 1, wherein the first level of access includes one or more of a view access, a comment access, and an edit access to the first portion and one or more of the view access, the comment access, and the edit access to the second portion, and the second level of access includes one or more of the view access, the comment access, and the edit access to the first portion and one or more of the view access, the comment access, and the edit access to the second portion.

9. A device, comprising:
a memory; and
at least one processor coupled with the memory and configured to cause the device to:
receive a portioned file from a first user account, the portioned file comprising at least a first portion of the portioned file, a second portion of the portioned file, and access instructions indicating the second portion is accessible by a second user account associated with the device;
display, via a graphical user interface of the device, the portioned file; and
receive user input, via the graphical user interface and based at least in part on the access instructions, to access the second portion indicated to be accessible by the second user account.

10. The device of claim 9, wherein the access instructions are generated by an artificial intelligence algorithm based at least partially on an agenda.

11. The device of claim 10, wherein the agenda is an email received on a device associated with the first user account.

12. The device of claim 10, wherein the agenda grants a level of access of the second portion to the second user account.

13. The device of claim 12, wherein the level of access includes access to the second portion of the portioned file and restricts access to the first portion of the portioned file.

14. The device of claim 9, wherein to access the second portion includes at least one of view access, comment access, and edit access to the second portion.

15. A method, comprising:
receiving access instructions that indicate a first portion of a file is accessible by a first user account and a second portion of the file is accessible by a second user account;
generating, based at least in part on the access instructions, a portioned file by granting a first level of access of the portioned file to the first user account, and by granting a second level of access editing access of the portioned file to the second user account, the first level of access being different from the second level of access; and
transmitting, over a network, the portioned file from the first user account to the second user account.

16. The method of claim 15, wherein the access instructions are generated by an artificial intelligence algorithm based at least partially on a received agenda.

17. The method of claim 16, wherein the received agenda is an email received by the first user account.

18. The method of claim 16, wherein the received agenda specifies the first level of access and the second level of access.

19. The method of claim 15, wherein the first level of access includes access to the first portion of the file and restricts access to the second portion of the file, while the second level of access includes access to the second portion of the file and restricts access to the first portion of the file.

20. The method of claim 15, wherein the first level of access includes one or more of a view access, a comment access, and an edit access to the first portion and one or more of the view access, the comment access, and the edit access to the second portion, and the second level of access includes one or more of the view access, the comment access, and the edit access to the first portion and one or more of the view access, the comment access, and the edit access to the second portion.
